(19) United States
(12) Patent Application Publication
(10) Pub. No.: US 2022/0108629 A1
(43) Pub. Date: Apr. 7, 2022

(54) Personal Hygiene System

(71) Applicant: Nancy Iannitelli, Naples, FL (US)

(72) Inventor: Nancy Iannitelli, Naples, FL (US)

(21) Appl. No.: 17/166,174

(22) Filed: Feb. 3, 2021

Related U.S. Application Data
(60) Provisional application No. 63/087,465, filed on Oct. 5, 2020.

(51) Int. Cl. G09B 19/00; A47K 7/03

(52) U.S. Cl. CPC G09B 19/0076; A47K 7/03

(57) ABSTRACT

A personal hygiene system for teaching proper handwashing techniques to a child. The personal hygiene system comprises at least one hygiene training device. The hygiene training device may comprise a squishy, rubber-like toy made up of water-resistant material. The toy can be used underneath a sink faucet or in the bath for play, thus offering a way to encourage the child to wash hands for a prolonged period of time. The toy after being used under water for washing hands, is dried off, and then stored on the ring or on a shelf. The personal hygiene system may further comprise at least one training adjunct for use with the toy. The at least one training adjunct may be a video, movie, book, or other media configured for use with the toy to engage and motivate the child in hand washing and maintaining hand hygiene. A method of using the system is also disclosed.

### CROSS-REFERENCE TO RELATED APPLICATION

The present application claims priority to, and the benefit of, U.S. Provisional Application No. 63/087,465, which was filed on Oct. 5, 2020 and is incorporated herein by reference in its entirety.

### FIELD OF THE INVENTION

The present invention relates generally to the field of personal hygiene. More specifically, the present invention relates to a personal hygiene system for use to promote hand washing in children. The novel personal hygiene system is configured to engage a child as a hand washing aid. Accordingly, this disclosure makes specific reference thereto. Nonetheless, it is to be appreciated that aspects of the present invention are also equally applicable to other like applications, devices and methods of manufacture.

### BACKGROUND

By way of background, hands are the most exposed part of the body and interact with more germs than any other route of entry onto or into the body. Germs accumulate on the hands from a variety of sources, including direct hand-to-hand contact and touching surfaces other people have touched. The invisible microbes cause some of the most dangerous diseases especially in children. Children touch all types of unsanitary surfaces such as floor, walls and then unintentionally touches their nose, face and takes the dirty hands in their mouth as well. These microbes then enter the body through the nose or mouth causing illness and various types of diseases. Children are particularly vulnerable to illness and diseases where there is a heightened risk of disease transmission due to crowded households, unsanitary surfaces, environmental contamination, and children's reluctance to hand washing.

Hand washing is one of the best defenses to protect children from these microbes. Children need to wash their hands whenever they may come into contact with a potentially contaminated surface, especially before or after certain activities such as before having a meal. Handwashing with soap is one of the most effective method to reduce the risks of diseases caused due to microbes present on dirty hands.

Despite the well-known benefits of hand hygiene, handwashing rates remain low for children. Further, handwashing promotion techniques and methods are not currently very effective to promote hand washing in children. Children are often distracted with toys and forget to wash hands. It is rare for children to demonstrate a sufficient level of scrupulous hand washing to prevent spreading germs. Even when hand washing is done, the hands are usually not rubbed long enough and not all areas of the hands are scrubbed. As such, compliance in hand hygiene in children is lacking or inadequate leading to potentially dangerous bacterial and viral epidemics that become more and more frequent due to bad hand hygiene.

Children may get bored after few seconds of washing hands and just abandon washing their hands causing the handwashing process to be ineffective. Children do not always enjoy washing their hands, because it takes time out from more exciting things like playing. Toys are used by children for entertainment but may be adapted for other purposes such as education and training. However, toys currently used by children do not inspire children to maintain personal hygiene such as motivate children to wash hands or making hand washing a fun activity.

Therefore, there exists a long felt need in the art for multifunctional child friendly personal hygiene system that can encourage and engage children to wash hands periodically and for a longer duration to maintain proper personal hygiene. There is also a long felt need in the art for a child friendly personal hygiene device that is manufactured from water resistant material that enables a child to wash toys for a longer time and thus encouraging them to wash their hands. Finally, there is a long felt need in the art for a child friendly personal hygiene system that makes hand washing part of the fun, rather than a distraction from children's favorite activities of playing with toys.

In this manner, the child friendly personal hygiene system of the present invention accomplishes all of the forgoing objectives, and provides a relatively safe, easy, convenient and cost-effective solution to engage and motivate children to wash hands regularly and adequately prevent from pathogens and infections. The personal hygiene system is configured to promote proper hand hygiene at an early age and teach proper hygiene techniques in a child friendly manner. A method of teaching proper hand hygiene using the personal hygiene system is also disclosed.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a personal hygiene system. The personal hygiene system comprises at least one hygiene training device. The at least one hygiene training device may be configured as a toy that is designed to motivate and engage a child to wash hands for a prolonged period of time to maintain proper hand hygiene. The hygiene training device is a water-resistant toy made up of a soft and flexible material. The toy may be configured to change colors or expand in size on being in contact with water to engage the children in hand washing activity. The hygiene training device may further comprise an attached ring for hanging it in the shower, on a backpack, and other similar areas.

The personal hygiene system further comprises at least one training adjunct. The at least one training adjunct is configured for use with the at least one hygiene training device to educate and train the child in proper hand washing techniques. The at least one training adjunct may comprise a training video, an educational movie, a short story, a book, or other training media that is associated with the hygiene training device to encourage the child to wash hands.

In yet another embodiment of the present invention, a method for engaging children to periodically wash hands for an appropriate duration is disclosed. The method comprises the steps of providing at least one hygiene training device wherein the at least one hygiene training device is made up of a water-resistant material. The at least one hygiene training device may be configured to create sound or change color on coming in contact with the water to engage the child in washing the hands. The method continues by providing at least one training adjunct. The at least one training adjunct may comprise a training video, an educational movie, a short story, a book, or other training media to encourage the child to wash hands. The at least one training adjunct is configured to be associated with the toy to encourage the child to play with the hygienic training device in water such as underneath a sink faucet or in the bath and drying off the toy after play The method ends by using an attached ring on the hygiene training device to store the hygiene training device for future use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an embodiment of a hygiene training device and a plurality of training adjuncts of a personal hygiene system of the present invention for training a child to wash their hands in accordance with the disclosed structure;

FIG. 2 illustrates a perspective view of the hygiene training device of the present invention in accordance with the disclosed structure;

FIG. 3 illustrates a perspective view of a child playing with a plurality of the hygiene training devices of the present invention in accordance with the disclosed structure;

FIG. 4 illustrates a perspective view of the child learning proper hand hygiene using one of the hygiene training devices of the present invention while washing their hands in accordance with the disclosed structure;

FIG. 5 a perspective view of the hygiene training device of the present invention in accordance with the disclosed structure; and

FIG. 6 illustrates a flowchart of a method for learning proper hand washing techniques using the personal hygiene system of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a personal hygiene system that can encourage and engage children to wash hands periodically and for a longer duration to maintain proper personal hygiene. There is also a long felt need in the art for a personal hygiene training aid that is manufactured from a water resistant material that enables children to wash toys for a longer time and thus encouraging them to wash their hands. Additionally, there is a long felt need in the art for a plurality of training adjuncts such as videos, movies, short stories, books, and other media encouraging children to wash their hands. Moreover, there is a long felt need in the art for a personal hygiene training aid that has unique colors and design such as alien or superhero designs to attract children to play with them and wash them. Further, there is a long felt need in the art for a personal hygiene training aid that produces a unique sound as indication to wash them after a certain period of time to encourage children to wash them and in the process, wash their hands. Finally, there is a long felt need in the art for a personal hygiene system that makes hand washing fun, rather than a distraction from children's favorite activities of playing with toys.

The present invention, in one exemplary embodiment, is a novel personal hygiene system for motivating and engaging a child to wash hands for a prolonged period of time to maintain hand hygiene. The personal hygiene system comprises one or more personal hygiene training aids in the form of water-resistant toys made up of soft and flexible materials. The toys are of different designs such as aliens having different colors and shapes, the toys change colors and/or expand in size on being in contact with water to engage the children in hand washing activity. The personal hygiene system further comprises and a plurality of training adjuncts to encourage the child to wash hands.

The toys and method of using the toys herein, teaches a child to properly clean their hands during use and reduces the amount of dirt spread about the home by hand contact and prevents the ingestion and transmission of harmful germs. The toy provides entertainment in a way that ensures the recommended duration of hand washing and method of hand washing is achieved by the child. Additionally, the toy operates to scrub the skin with soap, removes the need for any actual skill on the child's part for doing so. Because the toy is fun to operate, it encourages use for sufficient durations to disinfect hands by making the act play time.

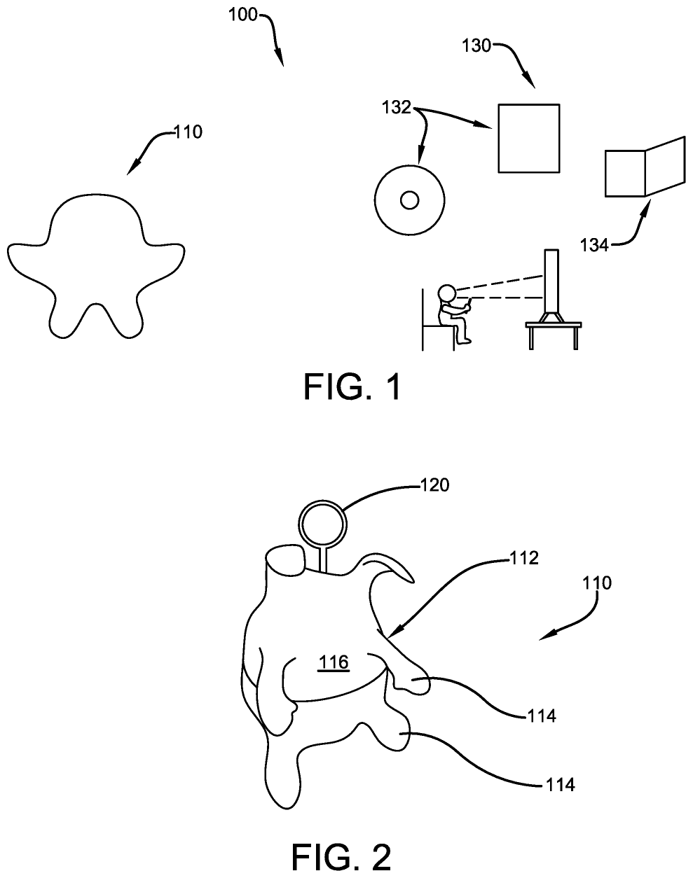

Referring initially to the drawings, FIG. 1-5 illustrate a personal hygiene system 100. The personal hygiene system 100 comprises at least one hygiene training device 110. The hygiene training device 110 comprises a body 112 comprising a plurality of appendages 114 and an external surface 116. The hygiene training device 110 may take the shape of a squishy rubber toy in the form a unique alien or a cartoon character having multiple colors to attract a child. The body 112 is water resistant and floats in water. The external surface 116 is such that the hygiene training device 110 is cleaned with water when a child plays with the hygiene training device 110 under a faucet, in a tub or in the bath. The body may be manufactured from natural rubber, cornstarch rubber, neoprene rubber and the like.

The external surface 116 may comprise a textured element 118 such as a velvety fuzzy surface that provides additional sensory stimulation. The hygiene training device 110 further comprises a storing element 120. The storing element 120 may be a ring attached to the body 112 to hang the hygiene training device 110 in a shower, attach it to a backpack, or attach to any other storage location. The external surface 116 may also be configured to change color when exposed to water.

The hygiene training device 110 may expand in size up to 1.5 times of the original size when a child plays with the hygiene training device 110 in water, thus engaging the child to play with the hygiene training device 110 in water while washing the hands simultaneously. When the hygiene training device 110 is dried off after play, the hygiene training device 110 shrinks and returns to the original size.

The hygiene training device 110 is safe for children and can be put in the mouth for chewing as well. The hygiene training device 110 is ecofriendly and may have a squishy form. The hygiene training device 110 may be a single unit body or may have removable components such as arms and/or legs may be replaced with other components of different colors and designs to customize the appearance of the hygiene training device 110.

As illustrated in FIG. 5, the hygiene training device 110 may further comprise a bladder 122. The bladder 122 may be positioned within the body 112. A valve 124 may extend from the bladder through the external surface 116 to access the bladder 122. The bladder 122 may be configured to retain a liquid, such as a soapy liquid to aid in hand washing. The hygiene training device 110 may further comprise a second bladder 126. The second bladder 126 may be positioned within one of the appendages 114 of the body 112. The second bladder 126 is configured to hold air. A noise generating element 128 in communication with second bladder 126 and penetrating the external surface 116 may be configured to generate and emit a noise when the body 112 is squeezed.

The personal hygiene system 100 further comprises at least one training adjunct 130. The at least one training adjunct 130 is configured for use with the personal hygiene device 110 to teach the child to properly wash their hands. The at least one training adjunct 130 may comprise an audiovisual media, a written media, or a combination thereof. The at least one training adjunct 130 may be a training video, an educational movie, a short story, a book, or other training media that is associated with the hygiene training device 110 to encourage the child to wash hands. The videos and movies may be used to make the child learn about the tricks and different ways of playing with the personal hygiene device 110. Also, the books may have pictorial instructions to assemble, disassemble and play with the personal hygiene device 110.

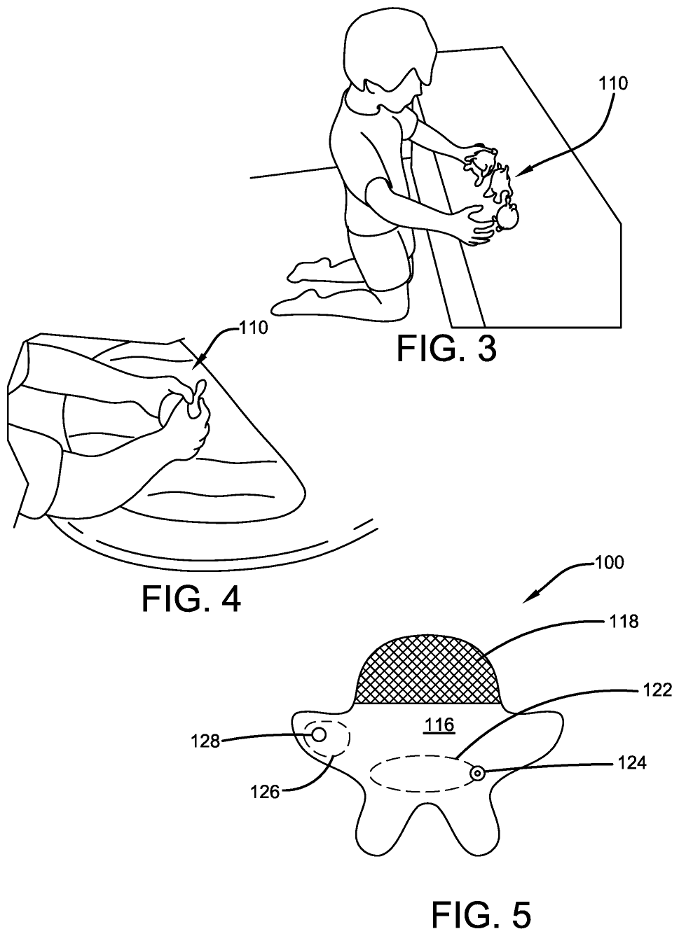

FIG. 3 illustrates a child playing with a plurality of the personal hygiene device 110 the present invention. The personal hygiene device 110 may have different shapes, sizes and colors. The personal hygiene devices 110 may be alien, a cartoon, or a superhero in shape and design. The child can hold one or more of the personal hygiene devices 110 in the hand and play to produce a sound by squeezing the personal hygiene device 110 toy, change color or disassemble or assemble the arms, legs, ears and/or torso. The personal hygiene device 110 may further comprise logos, indicia, trademarks, geometric patterns, customizable colors and fonts, embroidery and prints and/or images on the external surface 116. Further, the personal hygiene device 110 may be scented to have a pleasing fragrance.

FIG. 4 illustrates a child playing with the personal hygiene device 110 of the present invention while washing their hands. The advantage of the personal hygiene device 110 is that the personal hygiene device 110 can be used to promote and engage hand washing activity for a child. The personal hygiene device 110 is manufactured of a water-resistant material and gets cleaned during the hand washing. The child keeps playing with the personal hygiene device 110 in a sink of water while washing their hands. The personal hygiene device 110 is then dried off and can be attached to a backpack, pocket or on a wall when not in use.

The personal hygiene device 110 may be made available in different sizes and colors to accommodate user need and/or preference, and the exact size, measurement, construction and design specifications of the personal hygiene device 110 of the present invention may vary upon manufacturing or the particular material that is used. The external surface 116 of the personal hygiene device 110 may be partially flat and smooth but may optionally contain raised and/or lowered portions which may help aid in a hand cleaning process.

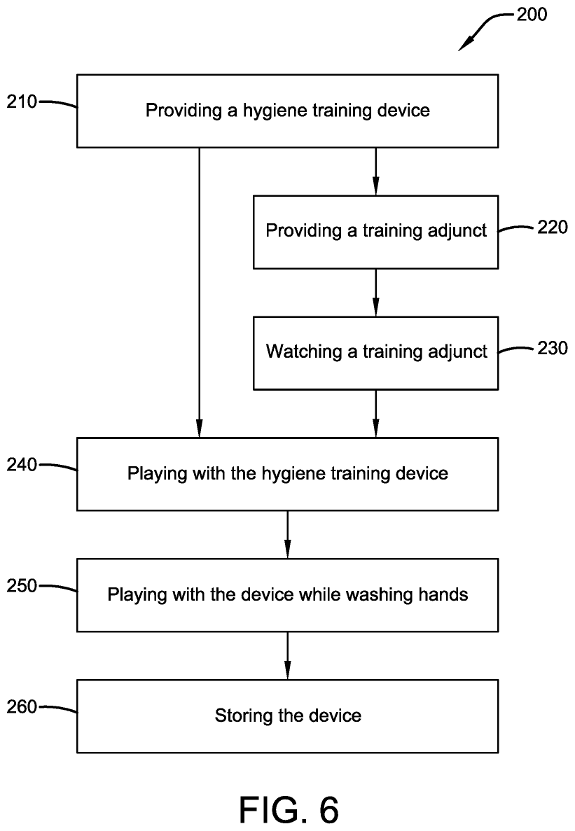

In an additional embodiment as illustrated in FIG. 6, a method 200 of teaching a child proper handwashing using a hygiene training system 100 is disclosed. The method 200 begins at 210 by providing a personal hygiene device 110. At 220, a training adjunct 130 may be provided. The training adjunct 130 may be an audiovisual media 132, a written media 134, or a combination thereof, designed to teach proper handwashing techniques in conjunction with the personal hygiene device 110. At 230, the child watches or reads the training adjunct 130 to reinforce the proper handwashing techniques. Then the child may play with the personal hygiene device 110 out of water at 240 and then play with the personal hygiene device 110 under water at 250. Once the child had completed the handwashing, the personal hygiene device 110 may be stored at 260 for future use.

It should be appreciated that there can be infinite number of embodiments of the present invention because of the variety of characters or things that could be portrayed. Additionally, the personal hygiene device 110 of the present invention could be provided as separate components, or as a packaged craft kit, including accessories, art, or decorating supplies, such as markers, colors, paints, and brushes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multifunctional hand scrub toys product”, “novel toy set”, “alien toy”, “squish rubber toy” and “multifunctional child friendly toys product” are interchangeable and refer to the multifunctional hand scrub toys product 100 of the present invention.

Notwithstanding the forgoing, the multifunctional hand scrub toys product 100 of the present invention can be of any suitable size and configuration as is known in the art without affecting the overall concept of the invention, provided that it accomplishes the above stated objectives. One of ordinary skill in the art will appreciate that the size, configuration and material of the personal hygiene device 110 of the personal hygiene system 100 as shown in the FIGS. are for illustrative purposes only, and that many other sizes and shapes of the personal hygiene device 110 are well within the scope of the present disclosure. Although the dimensions of the personal hygiene device 110 are important design parameters for user convenience, the personal hygiene device 110 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hygiene training device for teaching a child proper handwashing techniques comprising:
a body comprising a plurality of appendages and an external surface; and
a storage element attached to the body; and
wherein the body is water resistant.

2. The hygiene training device of claim 1, wherein the external surface comprises a textured element.

3. The hygiene training device of claim 1, wherein the body temporarily expands when exposed to water.

4. The hygiene training device of claim 1, wherein the external surface changes color when exposed to water.

5. The hygiene training device of claim 1, wherein the body floats in water.

6. The hygiene training device of claim 1 further comprising a bladder positioned within the body, and a valve extending from the bladder through the external surface.

7. The hygiene training device of claim 6, wherein the bladder is configured to retain a soapy liquid.

8. The hygiene training device of claim 6, wherein the valve is configured to emit a noise when the body is squeezed.

9. The hygiene training device of claim 1 further comprising a first bladder positioned within the body and a second bladder positioned within one of the appendages.

10. The hygiene training device of claim 9, wherein the first bladder is configured to hold a liquid and the second bladder is configured to hold air.

11. A hygiene training system for teaching a child proper handwashing techniques comprising:
a hygiene training device comprising:
a body comprising:
a plurality of appendages and an external surface; and
a storage element attached to the body; and
at least one training adjunct for use with the hygiene training device.

12. The hygiene training system of claim 11, wherein the at least one training adjunct is an audiovisual media.

13. The hygiene training system of claim 11, wherein the at least one training adjunct is a written media.

14. The hygiene training system of claim 11, wherein the external surface comprises a textured element.

15. The hygiene training system of claim 11, wherein the body temporarily expands when exposed to water.

16. The hygiene training system of claim 11, wherein the external surface changes color when exposed to water.

17. The hygiene training system of claim 11 further comprising a bladder positioned within the body, and a valve extending from the bladder through the external surface.

18. A method of teaching a child proper handwashing using a hygiene training system comprising the steps of:
providing at least one hygiene training device;
allowing a child to play with the hygiene training device;
positioning the hygiene training device under water;
using the hygiene training device to wash the child's hands;
storing the hygiene training device once hand washing is complete.

19. The method of claim 18 further comprising the step of providing at least one training adjunct configured to teach a child proper hand washing techniques.

20. The method of claim 19, wherein the at least one training adjunct is an instructional video or an instructional book.
